(19) United States
(12) Patent Application Publication
(10) Pub. No.: US 2025/0216411 A1
(43) Pub. Date: Jul. 3, 2025

(54) ILLUMINATED WIND DETECTION DEVICE

(71) Applicant: Gary TRANSUE, Pipersville, PA (US)

(72) Inventor: Gary TRANSUE, Pipersville, PA (US)

(21) Appl. No.: 18/402,082

(22) Filed: Jan. 2, 2024

(51) Int. Cl. G01P 13/00; G01P 13/02

(52) U.S. Cl. CPC G01P 13/0093; G01P 13/02

(57) ABSTRACT

An illuminated wind detection device is shown and described. The illuminated wind detection device includes a container configured to hold a powder material therein and a spray cap configured to secure to the container. The spray cap is configured to disperse a cloud of the powder material from the container into the air. The spray cap is further comprised of a light is configured to illuminate the cloud of the powder material. A D-ring connector is secured to the device.

### BACKGROUND OF THE INVENTION

The present invention relates to wind detection devices. More particularly, the present invention provides a bottle capable of spraying a powder which includes a light such that the powder will be illuminated when sprayed.

When hunting it is often important to know the wind direction for various reasons. For example, waterfowl tend to land into the wind. Knowing the wind direction helps when setting up a decoy spread.

It is well known that most mammals have a keen sense of smell. When hunting animals such as deer or coyotes it is important to set up such that the wind will carry one's scent away from the direction the animals are expected to come from. The wind direction also plays a key role if one is stalking up on animals. It is best to have the wind blowing from the animals toward the hunter to help mask the approach.

Many hunting hours are best done either when the sun first comes up or as the sun sets; in some cases predatory animals such as coyotes are hunted at night. This means that roughly half of hunting set ups, in the scenarios described, are done before the sun comes up, or in the dark.

The are a few different ways to detect wind direction, however, none seem to work quite as well as projecting a small cloud of powder or dirt into the air and watching where the wind carries it. This technique will show the wind direction even if no wind seems to be present. However, this method does not work well in the dark because, in order to see the could light by reflect from the powder.

Consequently, there is a need for an improvement in the art of wind detection. The present invention substantially diverges in design elements from the known art while at the same time solves a problem many people face when attempting to discern the wind direction in the dark. In this regard the present invention substantially fulfills these needs.

### SUMMARY OF THE INVENTION

The present invention provides an illuminated wind detection device wherein the same can be utilized for providing convenience for the user when using an illuminated wind detection device. The illuminated wind detection device includes a container configured to hold a powder material therein. A spray cap configured to secure to the container. The spray cap is configured to disperse a cloud of the powder material from the container into the air. The spray cap includes a light which is configured to illuminate the cloud of the powder material.

Another object of the illuminated wind detection device is to have a power source located within the spray cap. The power source is operably coupled to the light.

Another object of the illuminated wind detection device is to have the spray cap include a spray plunger.

Another object of the illuminated wind detection device is to have the light be configured to illuminate when the spray plunger is depressed.

Another object of the illuminated wind detection device is to have the spray cap include at least one electrical contact. The electrical contact is configured to activate the light when the spray plunger is depressed.

Another object of the illuminated wind detection device is to have a spray device operably coupled to the spray cap.

Another object of the illuminated wind detection device is to have the spray device is configured to release a measured amount of powder material into the air.

Another object of the illuminated wind detection device is to have a loop connector secured to the spray cap.

Another object of the illuminated wind detection device is to have a loop connector secured to container.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of an embodiment of the illuminated wind detection device.

FIG. 2A shows an exploded view of an embodiment of the illuminated wind detection device.

FIG. 2B shows an exploded view of an embodiment of the cap of the illuminated wind detection device.

FIG. 3 shows an in-use view of an embodiment of the illuminated wind detection device.

### LIST OF REFERENCE NUMERALS

With regard to the reference numerals used, the following numbering is used throughout the drawings.

| | |
|---|---|
| 101 | Container |
| 101a | Threads |
| 102 | Spray cap |
| 102a | securement portion |
| 102b | Spray device |
| 102c | Spray plunger |
| 103 | Powder substance |
| 104 | Loop connector |
| 201 | Opening |
| 201a | Spray nozzle |
| 202 | Plunger cover |
| 203 | Contact plate |
| 204 | Light |
| 205 | Power source |
| 206 | Aperture |
| 301 | Depression |
| 302 | Cloud |
| 303 | Beam |
| 304 | D-Ring |

### DETAILED DESCRIPTION OF THE INVENTION

Reference is made herein to the attached drawings. Like reference numerals are used throughout the drawings to depict like or similar elements of the illuminated wind detection device. For the purpose of presenting a brief and clear description of the present invention, a preferred embodiment will be discussed as used for the illuminated wind detection device. The figures are intended for representative purposes only and should not be considered to be limiting in any respect.

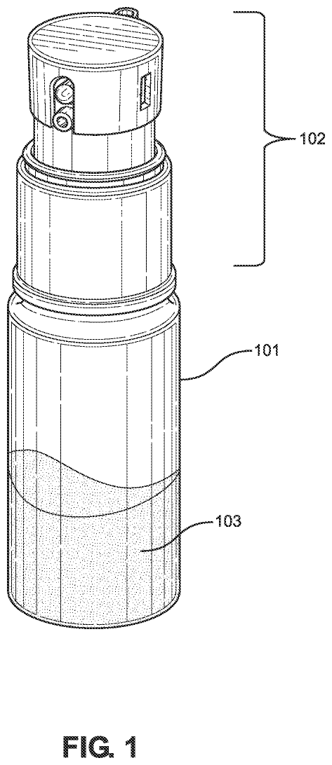

Referring now to FIG. 1, there is shown a front view of an embodiment of the illuminated wind detection device. The illuminated wind detection device is comprised of a container 101. In one embodiment the container 101 is a bottle. In another embodiment other containers may be used. The container 101 is configured to have an opening which will allow for a spray cap 102 to be secured thereto. As will be discussed below the spray cap 102 includes several features of the illuminated wind detection device.

The container 101 is further configured to hold a powder substance 103. In different embodiments the powder substance 103 may be talc powder, flour, dry dirt or other substances capable of creating a cloud of particles in the air when dispersed. In different embodiments the powder substance 103 is different colors. One standard color for many of the materials described is white. However, the powder substance 103 is not limited to a white color.

In one embodiment the illuminated wind detection device includes a loop connector 104. In the shown embodiment the loop connector 104 is secured to the spray cap 102. However, in other embodiments the loop connector is secured to the container 101. The loop connector 104 is configured to have a D-Ring or other connector secured thereto.

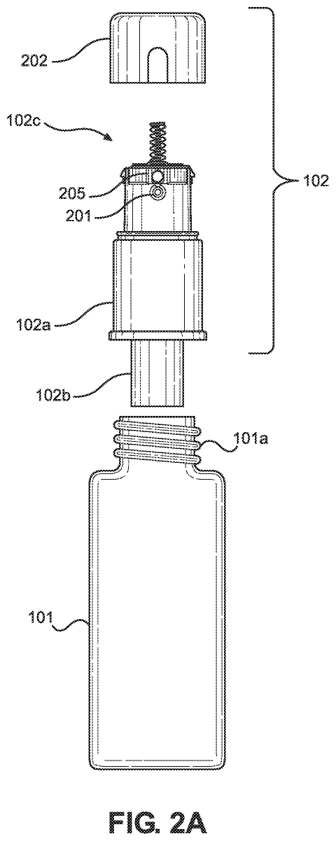

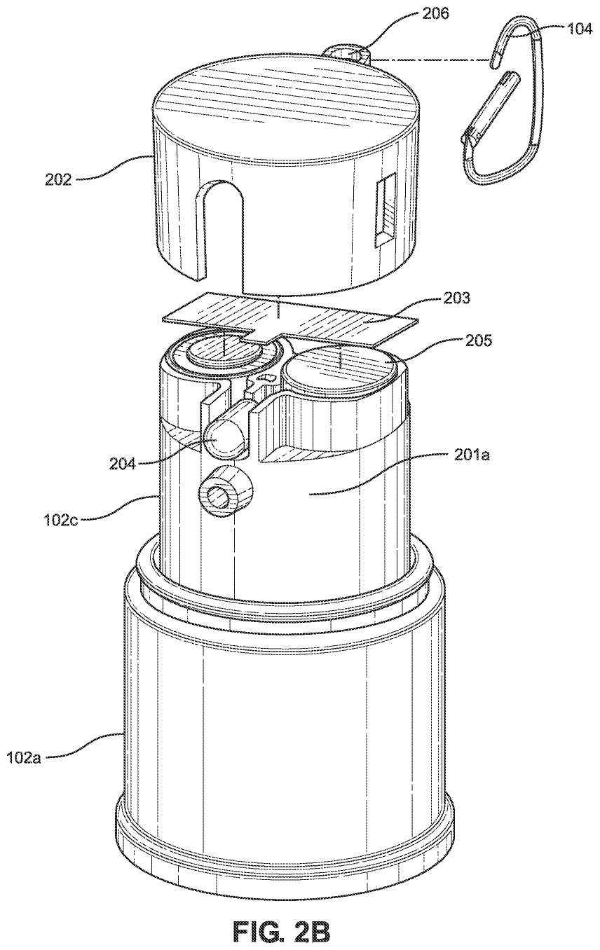

Referring now to FIG. 2A and FIG. 2B, there is shown exploded views of an embodiment of the illuminated wind detection device. In the shown exploded view there is shown one embodiment of the illuminated wind detection device. In this embodiment the illuminated wind detection device includes the container as described above 101. In the shown embodiment the container 101 includes a threaded opening 101a. This will allow for spray cap 102 to be screwed onto the container 101.

In this embodiment the spray cap 102 includes three major components, however, other components may be included without departing from the present invention. The spray cap 102 includes a securement portion 102a. The securement portion 102a will hold the spray cap 102 together. Further the securement portion 102a will allow for the spray cap 102 to be secured to the container 101.

The spray cap 102 further includes a spray device 102b. The spray device 102b is configured to remove a portion of powder substance from the container 101 and disperse it through the spray cap 102 into the air. In order to facilitate the spraying of the material the spray device 102b is operably coupled to an opening 201 located in a spray plunger 102c. The opening 201 will house a spray nozzle 201a. The spray plunger 102c will be movably secured to the securement portion 102a and the spray device 102b such that when it is depressed a measure of the powder material will be sprayed into the air thought the spray nozzle 201a and the opening 201.

The spray plunger 102c is made up of additional components. In the shown embodiment the spray plunger 102c includes a plunger cover 202. Beneath the plunger cover 202 is an electrical contact plate 203. The electrical contact plate 203 is operably coupled to a light 204 and a power source 205. In the shown embodiment the power source 205 is a battery. When the spray plunger 102c is pressed the electrical contact plate 203 will engage the power source 205 and cause the light 204 to illuminate. The light will show through an aperture 206 configured to secure the light 204.

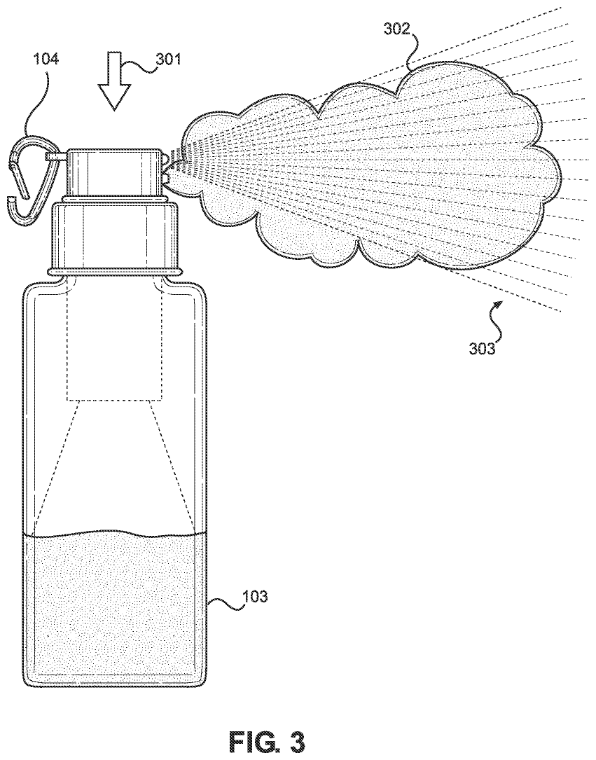

Referring now to FIG. 3, there is shown an in-use view of an embodiment of the illuminated wind detection device. In this embodiment a D-ring 304 is secured to the spray cap 102. The D-ring 304 will allow a user to attached the device to themselves or their equipment as needed to ensure that the device is not lost.

In use the illuminated wind detection device will allow a user to detect the direction of the wind no matter the time of day or night. When the spray plunger 102c is depressed 301 the illuminated wind detection device will spray a cloud 302 of powder material 103 into the air. During the day a user will be able see the cloud 302 and observe the direct traveled thus ascertaining the wind direction.

When it is dark out a normal cloud 302 of powder material 103 may be undetectable. In this situation the illuminated wind detection device will still be able to allow a person to detect the wind direction. In addition to spraying a cloud 301 into the air when the spray plunger 102c is depressed 301 the light will illuminate casting a light beam 303 onto the cloud 302.

In this embodiment the light beam is shown coming from the base of the spray cap 102. In this embodiment the light is placed in the spray cap 102 itself and not the spray plunger 102c. The light beam 303 will reflect off of the cloud 302 and allow an individual to see the cloud 302 and the direction it travels. This will thus allow a user to detect the wind direction even in low light or no light conditions.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An illuminated wind detection device, the device comprising:
a container configured to hold a powder material therein;
a spray cap configured to secure to the container;
wherein the spray cap is configured to disperse a cloud of the powder material from the container into the air;
the spray cap is further comprised of a light is configured to illuminate the cloud of the powder material.

2. The illuminated wind detection device of claim 1, further comprising a power source located within the spray cap;
Wherein the power source is operably coupled to the light.

3. The illuminated wind detection device of claim 1, wherein the spray cap is further comprised of a spray plunger.

4. The illuminated wind detection device of claim 3, wherein the light is configured to illuminate when the spray plunger is depressed.

5. The illuminated wind detection device of claim 4, wherein the spray cap is further comprised of at least one electrical contact;
wherein the electrical contact is configured to activate the light when the spray plunger is depressed.

6. The illuminated wind detection device of claim 1, further comprising a spray device operably coupled to the spray cap.

7. The illuminated wind detection device of claim 6, wherein the spray device is configured to release a measured amount of powder material into the air.

8. The illuminated wind detection device of claim 1, further comprising a loop connector secured to the spray cap.

9. The illuminated wind detection device of claim 1, further comprising a loop connector secured to the cap.

10. The illuminated wind detection device of claim 1, further comprising a D-ring secured to the cap.

11. An illuminated wind detection device, the device consisting of:
a container configured to hold a powder material therein;
a spray cap configured to secure to the container;
wherein the spray cap is configured to disperse a cloud of the powder material from the container into the air;
The spray cap is further comprised of a light is configured to illuminate the cloud of the powder material;
a D-ring connector is secured to the device.
